(19) United States
(12) Patent Application Publication
(10) Pub. No.: US 2005/0269742 A1
(43) Pub. Date: Dec. 8, 2005

(54) Method for making tools for micro replication

(76) Inventors: Thomas S. Wright, Brockport, NY (US); Gerald T. Hertzel, Rochester, NY (US); David Kessler, Rochester, NY (US); Randall H. Wilson, Albuquerque, NM (US)

Correspondence Address: Paul A. Leipold;Patent Legal Staff, Eastman Kodak Company, 343 State Street, Rochester, NY, 14650-2201, US

(21) Appl. No.: 10/859,652

(22) Filed: Jun. 3, 2004

(51) Int. Cl. B29C 59/02; B29C 59/04

(52) U.S. Cl. 264/284; 264/293; 264/494; 264/495; 425/174.6

(57) ABSTRACT

A method includes electromechanical engraving a three-dimensional molding pattern (N) in a rigid surface. The rigid surface is configured to micro replicate according to the molding pattern (N). The rigid surface may be a pattern roller. The molding pattern may be for micro replication of optical elements (5) of a light redirecting film (2).

### FIELD OF THE INVENTION

Example embodiments of the present invention relate to a method of electromechanical engraving (e.g. Gravure electromechanical engraving) a molding pattern consisting of small, individual cavities, in a rigid surface for the specific purpose of micro replicating the inverse of said three-dimensional pattern into a continuous web of material.

### BACKGROUND OF THE INVENTION

Films with patterned surfaces are made for a variety of applications. For example, photographic paper may include a film with a matte or glossy finish. This matte finish or glossy finish may produce a desirable effect on a photograph when viewed by a casual observer. A glossy or matte finish requires a photographic paper manufacturing process with certain tolerances (i.e. a certain level of precision). As tolerances of a manufacturing process become tighter, the manufacturing process generally becomes more complicated and expensive. In other words, the tolerances required to produce a pattern film for photographic paper may be significantly lower than the tolerances required to manufacture a light redirecting film for a liquid crystal display.

A light redirecting film may be used in a variety of applications. For example, a light directing film may be used as part of a liquid crystal display (LCD) to increase the power efficiency of the LCD. Increasing the power efficiency of a LCD (or other similar display) may be significant. Liquid crystal displays are often included in mobile devices (e.g. cellular telephones, laptop computers, digital cameras, etc.) which run on batteries. It is desirable for these mobile devices to maximize the operating time of their batteries. Although battery technology is improving, one way to increase the battery life of a mobile device is to reduce power consumption of the device without degrading quality. By making liquid crystal displays more efficient, the battery life of a mobile device can be extended, which is of great benefit to the user.

The optics of a light redirecting films are very specific and detailed, compared to the optics of a glossy or matte finish on photographs. Accordingly, the precision of the manufacturing process for producing glossy or matte finishes on photographic paper may be inadequate for purposes of manufacturing light redirecting films. For example, the manufacturing process used to manufacture other patterned films may not adequately reproduce optical elements of a light redirecting film or provide a uniform thickness of the film, which may be required for a light redirecting film to be usable. These inadequacies of previous manufacturing processes are critical considerations to the manufacturing of light redirecting films.

### SUMMARY OF THE INVENTION

Example embodiments of the present invention relate to a method including electromechanical engraving of a molding pattern in a rigid surface (e.g. a pattern roller). Other example embodiments of the present invention relate to a method including micro replicating optical elements on a light redirecting film. Other embodiments of the present invention relate to an apparatus including a rigid surface. A molding pattern is formed in the rigid surface and is formed by electromechanical engraving (e.g. Gravure electromechanical engraving).

A molding pattern is a three-dimensional surface shape formed on a rigid surface, such that the negative of the three-dimensional surface shape is accurately imparted to the surface of an object molded from the rigid surface. The molding pattern in the present invention comprises many well-formed cavities cut in the rigid surface.

In accordance with example embodiments of the present invention, the manufacturing process is able to produce a molding pattern for light redirecting films that can be used in a variety of applications. For example, by using the manufacturing process in accordance with example embodiments of the invention, the light redirecting film can be produced with an accurate replication of specific optical elements. This replication of the specific optical elements allows for a film that can create a substantial increase in efficiency of a liquid crystal display. Accordingly, this increase in efficiency can extend the battery life of a mobile device (e.g. a cellular phone, laptop computer, digital camera, etc.) A manufacturing process of example embodiments will allow for a thin film to be produced with discrete optical elements. A light redirecting film without the discrete optical elements will not be effective in increasing the efficiency of a display device, without degrading the display quality.

### BRIEF DESCRIPTION OF THE DRAWINGS

FIG. 1 is a schematic side elevation view of a light redirecting film system, in accordance with example embodiments of the present invention.

FIG. 2 is an enlarged fragmentary side elevation view of a portion of a backlight and a light redirecting film system, in accordance with example embodiments of the present invention.

FIGS. 3 and 4 are schematic side elevation views of light redirecting film systems, in accordance with example embodiments of the present invention.

FIG. 5 shows a typical image cut by an electromechanical engraving machine, with cavities placed in a regular offset grid.

FIG. 6 shows another portion of a typical image cut by an electromechanical engraving machine, with cavities cut at various depths, size and shape.

FIG. 7 shows an illustration of an irregular or random pattern of intersecting cavities.

FIG. 8 shows an illustration of various types of neighboring, overlapping cavities.

FIG. 9 shows a cross-section of an individual cavity and how it was cut to the desired finished depth in multiple steps.

FIG. 10 shows cylinder configurations that contain small cavities, in accordance with example embodiments of the present invention.

### DETAILED DESCRIPTION OF THE INVENTION

There are numerous uses for cylinders with patterns of small cavities on their surfaces. Typically they are used to replicate the pattern of cavities in the cylinder surface into or onto another material in a continuous manufacturing process. For example, in Gravure printing, a series of cavities formed in a desired pattern on a cylinder surface are used to collect and then transfer ink or a coating material onto the surface of a continuous web.

Patterned cylinders may also be used in micro replication processes. In Ultraviolet (UV) curing replication, a material is applied to the cylindrical surface in a way to fill the cavities, the UV cured material cured by UV exposure and then separated from the cylinder. Other examples of micro replication processes include hot embossing and continuous extrusion molding. In hot embossing, a patterned cylinder is pressed under high pressure and temperature against a preformed polymer web to create a homogenous product with a micro structured surface. In continuous extrusion molding, a thin layer of molten polymer is pressed against a patterned cylinder to create a homogeneous product with a microstructured surface. The inherent appeal of a patterned cylinder, regardless of the process in which it is utilized, is its ability to enable manufacture of a product in a continuous manner. Continuous processes may provide lower manufacturing costs than batch processes.

Given the appeal of continuous manufacturing processes, one can efficiently create a cylinder containing the desired pattern of small cavities. Not only can one be able to create the exact desired pattern of small cavities, but also the time required to create the desired pattern over a large surface area must be reasonable. Surface areas to be patterned with small cavities typically range from 0.03 square meters to 2.2 square meters, most ranging from 0.32 square meters to 1.0 square meter. It is desirable that the process required to create the pattern of small cavities could be accomplished in less than three days.

Many techniques are known in the art for creating patterned cylinders, but the list of techniques becomes shorter when the desired pattern has some optical utility. There are numerous uses for replicated patterns of small cavities that have optical utility. These applications include, but are not limited to, holograms used in security and packaging applications, micro lens arrays for telecommunications and imaging systems applications and light redirecting films used in backlit display systems. Examples of light redirecting films include diffusers, light collimating films and polarization recovery and recycling films.

Diamond tooling can be utilized to achieve the surface quality and roughness characteristics required for the creation of optical features. The precisely shaped and polished diamond tooling can be engaged with the cylindrical surface using any one of a variety of techniques, to either remove, shape or form the material on the cylindrical surface. While diamond tooling is expensive, it is preferred to more common and less expensive alternative tool materials. Such alternative toll materials, such as carbide or high-speed steel are not be capable of producing optical quality features due to the relatively large grain size of the materials. This large grain size results in microchips along the cutting edges that will produce a surface with unacceptable roughness properties, thereby not meeting the requirements for a surface having optical utility. In order to produce optical quality features directly in a cylinder, the features can be cut, formed, scribed, ruled or otherwise created using a diamond tool or stylus.

Alternatives exist for indirectly creating a cylinder with the desired pattern of small cavities. For example one may create the desired pattern into a flat work piece, and through subsequent operations produce a flexible copy of the original that can be wrapped around a cylindrical surface. Utilizing such a technique will produce an easily detectable seam or line in the finished product, whose frequency is equal to the circumference of the cylinder. In some applications this may be acceptable, but in many applications it is not. This is particularly true when the finished product produced by replication or material transfer is of a length greater then the circumference of the cylinder.

It is well known that the time required to create a cylinder with the desired pattern of small cavities is a significant limitation of the various alternative methods for patterning such cylinders. In particular, the time required to create a cylinder with the desired pattern of small cavities can make the creation of such cylinders prohibitively expensive. All alternative processes have a capability to produce between one and ten features per second. At this rate, the time required to pattern an average cylinder used in a continuous manufacturing process would be measured in months. For example, if the desired pattern consists of 3,875 cavities per square centimeter and the surface area to be patterned is 1.0 square meter, at a rate of ten features per second, the time required to pattern a cylinder is approximately 43 days.

Known techniques exist in the art for producing continuous optical grooves on a cylinder using diamond turning. In this process, a non-rotating diamond tool is engaged with a rotating cylinder. Typically a symmetric tool is engaged normal to the surface of the cylinder to produce a symmetric groove, consisting of two or more angle surfaces. While it is engaged with the cylinder it also may be moved further into the surface or retracted from the surface of the cylinder to produce variations in feature depth. If this is done in a continuous, non-linear motion, the resulting groove will consist of two or more curved surfaces. U.S. Pat. No. 6,581,286 (Campbell et al.) describes such a process for forming simple, continuous features by thread cutting. The grooves produced by this process are symmetrical, continuous and consist of two curved surfaces.

In other applications the diamond tool is moved parallel, perpendicular or at an angle to the rotational axis of the cylinder or work piece while engaged. A combination of any or all of these motions can occur simultaneously and the choice of motion selected is a function of the desired shape of the cavity being produced. Example applications of this method include the fabrication of the individual segments of a large mirror surface assembly.

Example embodiments of the present invention create a molding pattern for micro replication including a metal cylinder that is patterned with small, individual, three dimensional cavities by electro-mechanical engraving for the specific purpose of replicating the inverse of said three dimensional pattern into a continuous web of material.

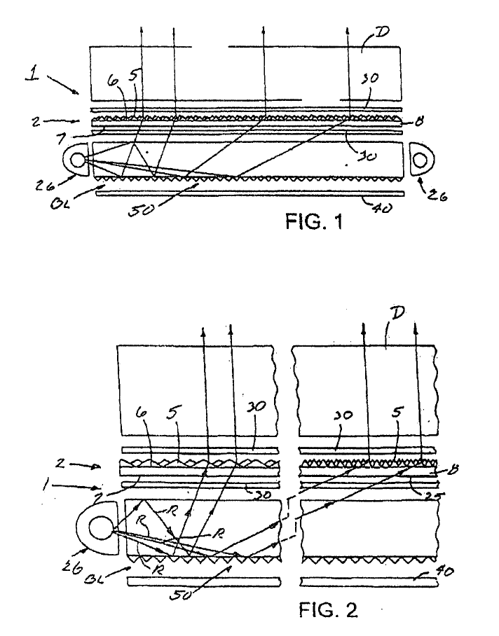

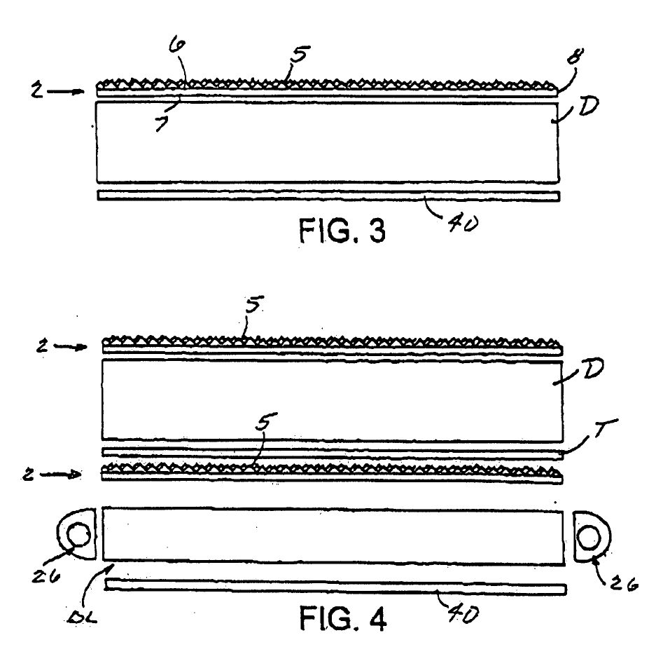

Example FIGS. 1 and 2 schematically show one form of light redirecting film system 1 in accordance with example embodiments of the present invention. Light redirecting film system 1 may include a light redirecting film 2 that redistributes more of the light emitted by a backlight BL (or other light source) toward a direction more normal to the surface of the film. Film 2 may be used to redistribute light within a desired viewing angle from almost any light source for lighting. For example, film 2 may be used with a display D (e.g. in a liquid crystal display, used in laptop computers, word processors, avionic displays, cell phones, and PDAs) to make the displays brighter. A liquid crystal display can be any type, including a transmissive liquid crystal display as schematically shown in example FIGS. 1 and 2, a reflective liquid crystal display as schematically shown in example FIG. 3, or a transflective liquid crystal display as schematically shown in example FIG. 4.

The reflective liquid crystal display D shown in example FIG. 3 may include a back reflector 40 adjacent the back side for reflecting ambient light entering the display back out of the display to increase the brightness of the display. The light redirecting film 2 in accordance with example embodiments of the present invention may be placed adjacent to the top of the reflective liquid crystal display to redirect ambient light (or light from a front light) into the display toward a direction more normal to the plane of the film for reflection back out by the back reflector within a desired viewing angle to increase the brightness of the display. Light redirecting film 2 may be attached to, laminated to or otherwise held in place against the top of the liquid crystal display.

The transflective liquid crystal display D shown in example FIG. 4 includes a transreflector T placed between the display and a backlight BL for reflecting ambient light entering the front of the display back out the display to increase the brightness of the display in a lighted environment, and for transmitting light from the backlight through the transreflector and out the display to illuminate the display in a dark environment. In example embodiments, the light redirecting film 2 may either be placed adjacent the top of the display or adjacent the bottom of the display or both as schematically shown in example FIG. 4 for redirecting or redistributing ambient light and/or light from the backlight more normal to the plane of the film to make the light ray output distribution more acceptable to travel through the display to increase the brightness of the display.

Light redirecting film 2 may include a thin transparent film or substrate 8 having a pattern of discrete individual optical elements 5 of well defined shape on the light exit surface 6 of the film for refracting the incident light distribution such that the distribution of the light exiting the film is in a direction more normal to the surface of the film.

Each of the individual optical elements 5 may have a width and length many times smaller than the width and length of the film, and may be formed by depressions in or projections on the exit surface of the film. These individual optical elements 5 may include at least one sloping surface for refracting the incident light toward the direction normal to the light exit surface. Optical elements 5 may have an aspect ratio greater than 0.5. Optical elements 5 may have a depth greater than 15 micrometers. These optical elements may take many different shapes. U.S. Patent Application Publication No. U.S. 2001/0053075 A1 titled “Light Redirecting Films and Film Systems” is hereby incorporated by reference in entirety. This application illustrates many variations of optical elements. However, one of ordinary skill in the art would appreciate other variations of optical elements of light redirecting systems that are covered by embodiments of the present invention.

As illustrated in example FIG. 2, light entrance surface 7 of the film 2 may have an optical coating 25 (e.g. an antireflective coating, a reflective polarizer, a retardation coating or a polarizer). Also, in example embodiments, a matte or diffuse texture may be provided on the light entrance surface 7 depending on the visual appearance desired. A matte finish may produce a softer image, that is not as bright. The combination of planar and curved surfaces of the individual optical elements 5 of example embodiments of the present invention may be configured to redirect some of the light rays impinging thereon in different directions to produce a softer image without the need for an additional diffuser or matte finish on the entrance surface of the film. The individual optical elements 5 of the light redirecting film 2 may also overlap each other in a staggered, interlocked and/or intersecting configuration, creating an optical structure with adequate surface area coverage.

The individual optical elements 5 may have multiple shapes and sizes on a light redirecting film 2. The individual optical elements 5 may also be placed on the surface in irregular patterns, where the spacing between neighboring elements varies. For example, random or pseudo-random placement of individual optical elements 5 on the light redirecting film 2 may be useful to avoid moiré patterns or other optical effects when the light redirecting film is placed in an assembly with other optical components.

Irregular patterns comprise cavities that are placed in such a way that they do not follow a regular pattern such as a matrix, grid, or linear arrangement. Random patterns comprise cavities with locations chosen by a random process.

The backlight BL may be substantially flat or curved. The backlight BL may be a single layer or multi-layers and may have different thicknesses and shapes. The backlight BL may be flexible or rigid and be made of a variety of compounds. Further, the backlight may be hollow, filled with liquid, air, or be solid, and may have holes or ridges.

The light source 26 may be of any suitable type (e.g. an arc lamp, an incandescent bulb which may also be colored, filtered or painted, a lens end bulb, a line light, a halogen lamp, a light emitting diode (LED), a chip from a LED, a neon bulb, a cold cathode fluorescent lamp, a fiber optic light pipe transmitting from a remote source, a laser or laser diode, or any other suitable light source). Additionally, the light source 26 may be a multiple colored LED, or a combination of multiple colored radiation sources in order to provide a desired colored or white light output distribution. For example, a plurality of colored lights such as LEDs of different colors (e.g., red, blue, green) or a single LED with multiple color chips may be employed to create white light or any other colored light output distribution by varying the intensities of each individual colored light.

A back reflector 40 may be attached or positioned against one side of the backlight BL as schematically shown in example FIGS. 1 and 2 in order to improve light output efficiency of the backlight by reflecting the light emitted from that side back through the backlight for emission through the opposite side. Additionally, a pattern of optical deformities 50 may be provided on one or both sides of the backlight as schematically shown in example FIGS. 1 and 2 in order to change the path of the light so that the internal critical angle is exceeded and a portion of the light is emitted from one or both sides of the backlight.

Thermoplastic films with textured surfaces have applications ranging from packaging to optical films. The texture may be produced in a casting nip that consists of a pressure roller and a patterned roller. Depending on the pattern being transferred to the thermoplastic film, it can be difficult to obtain a uniform degree of replication across the width of the film. It can also be difficult to obtain this uniform degree of replication and have a smooth backside to the film.

A typical extrusion roll molding system comprises an extruder that extrudes molten polymeric material into a nip. The nip is formed between a molding roller and a pressure roller. The molten polymer is forced into the molding roller pattern by the pressure roller and cools. The polymer exits the nip in a semi-solid to solid state. Rubber pressure rollers may be used to provide a relatively uniform pressure across the casting nip, since their coverings can deform to accommodate any thickness non-uniformities in a melt curtain. These thickness non-uniformities may be due to the presence of thick edges from neck-in or from other causes of non-uniform flow from the extrusion die. However, the rubber coverings may not have a surface with low enough roughness to produce a glossy (e.g. smooth) backside surface.

Example embodiments of the present invention relate to a method of electromechanical engraving a molding pattern in a rigid surface. The molding pattern may be for micro-replicating optical elements during manufacturing of light redirecting films. The electromechanical engraving may be Gravure electro-mechanical engraving. Gravure electro-mechanical engraving processes have been used to produce printing rollers in the printing industry. However, example embodiments of the present application use Gravure electromechanical engraving for the entirely different purpose of making a molding pattern.

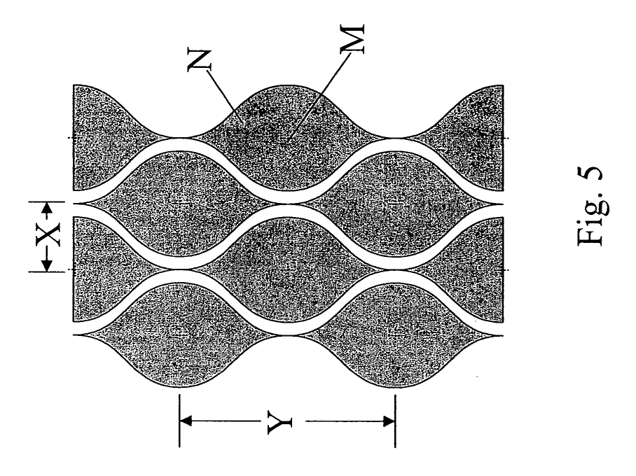

In typical electromechanical engraving, the cavities cut on a cylinder are placed in a regular pattern. FIG. 5 is an illustration of a portion of a typical image cut by an electromechanical engraving machine, showing cavities N with center points M placed in a regular offset grid with constant spacing X and Y between cavity centers. The vertical direction is aligned around the cylinder, and the horizontal direction is aligned with the axis of the cylinder. The spacings X and Y together define the screen and angle of the electromechanically engraved image, and they are constant across the image. The image is engraved by engraving a column of cavities in a single revolution of the cylinder, then moving the engraving head along the axis of the cylinder by the constant distance X, then engraving the next column of cavities, and repeating.

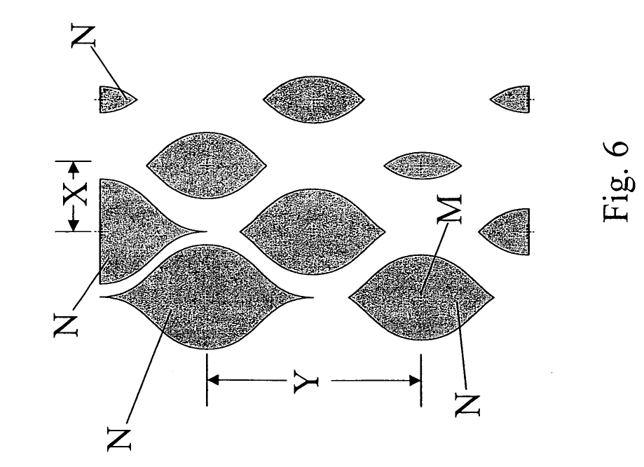

FIG. 6 is an illustration of another portion of a typical image cut by a Gravure electromechanical engraving machine. The cavities N are cut at varying depths into the surface of the cylinder, causing variations in cavity size and shape. The cavity depth variations are provided to transfer varying amounts of material, for example ink or a coating material, at that point in the image. However, the cavity locations are still arranged in columns with fixed spacing X. The electromechanical engraver always moves a constant distance from one column to the next. Repeating patterns of optical elements, such as those that would be produced by a typical electromechanical engraving process with constant offset between columns of cavities, can have detrimental optical effects such as moiré when the product is placed in an assembly with other optical components.

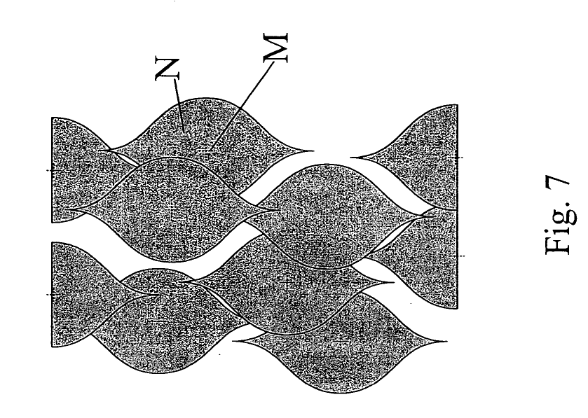

Example embodiments of the present invention significantly modify the electromechanical engraving process to provide irregular positioning of cavities for replicating three-dimensional micro-features. The electromechanical engraver may be modified to allow varying offset between columns of cavities, to allow arbitrary, irregular, or random cavity positions. The arbitrary, irregular, or random cavity positions may also cause the cavities to intersect and interlock in arbitrary, irregular, or random ways. FIG. 7 is an illustration of an irregular or pseudo-random pattern of intersecting cavities that might be cut according to one embodiment of the present invention. FIG. 7 shows cavities with gaps between them for simplicity of illustration. The cavity positions may also be irregular or random yet substantially cover the surface of the cylinder. The arbitrary, irregular, or random cavity positions and intersections can have beneficial effects for the product molded from the cylinder, including reduction of moiré effects in optical substrates.

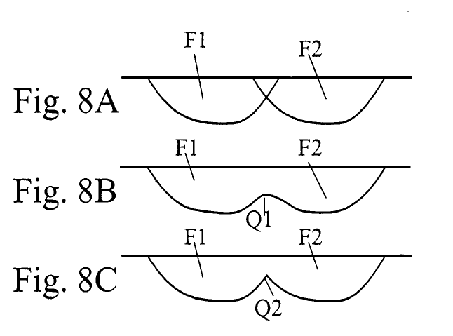

The varying offset between columns of cavities can also be allowed to be zero, thereby causing the electromechanical engraver to engrave multiple columns of cavities in the same X location. This capability can be useful in several ways for making tools for micro replication. The edges of neighboring cavities that are engraved sequentially by an electromechanical engraver cannot have sharp edges between them, due to momentum of the engraving head and stylus. FIG. 8A is an illustration of a side view of two neighboring overlapping cavities F1 and F2. In FIG. 8B, if the cavities are engraved in succession by an electromechanical engraver, they will have a rounded intersection point Q1. However, as illustrated in FIG. 8C, by engraving neighboring features F1 and F2 in two columns cut at the same location, a sharp transition Q2 can be achieved between the two cavities.

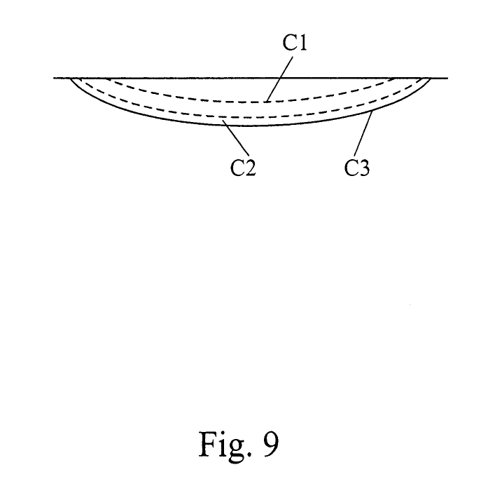

Tools for micro replication may need to have cavities that are deeper than can be cut in a single cut, or they may need to be made out of harder materials than are typically electromechanically engraved, such as nickel or nickel-phosphorous alloys. Engraving deep features in these harder materials might stress the diamond stylus to fracture, or optical-quality surfaces may no longer be achieved. Engraving multiple columns of cavities in the same X location can address these issues by cutting a cavity to increasing depths in each column. For example, as illustrated in FIG. 9, the first column of engraving might cut (C 1) the cavity to 50% of its final depth, the second column of engraving at the same location might cut (C2) the cavity to 90% of its final depth, and the third and final column of engraving at the same location might cut (C3) the cavity to its final depth. As a result the feature can be cut to arbitrary depths, the stylus is subjected to lower cutting forces, and the surface finish of the cavity can be of optical quality.

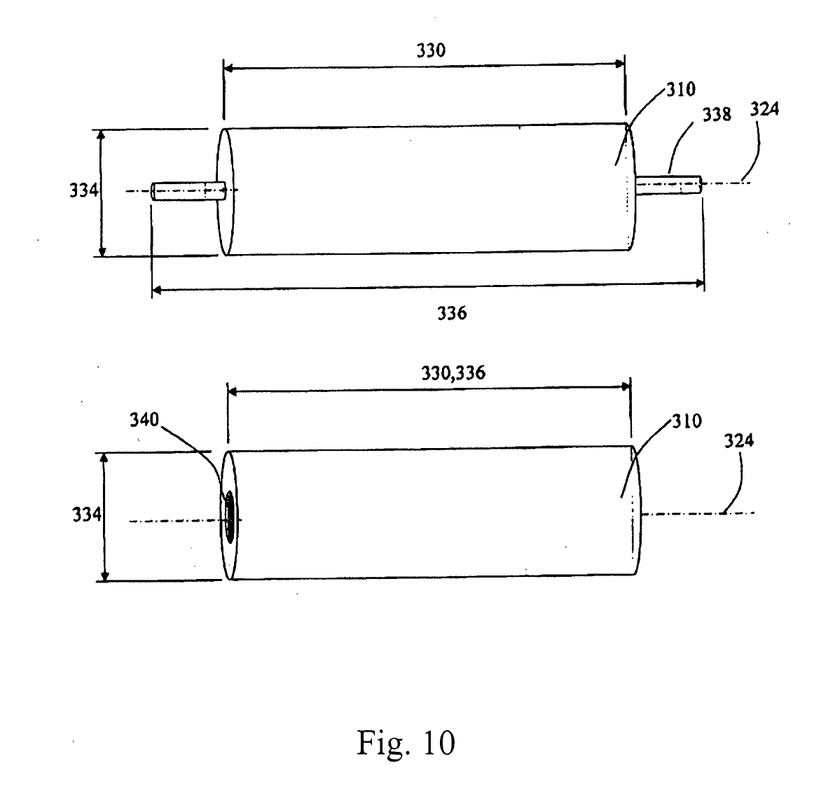

FIG. 10 is an illustration of a cylinder, 310, into which the desired pattern of cavities may be generated, in accordance with example embodiments of the present invention. The configuration of the cylinder can vary significantly, and is often customized for the specific end use. In all configurations the cylinder has a nominal diameter, 334, associated with a nominal face length, 330. The cylinder may either have shafts, 338, or a tapered mounting hole, 340, on the ends of the nominal diameter that define the axis of rotation, 324. The overall length of the cylinder, 336, may be equal to the face length if the cylinder does not have shafts. More typically the cylinder does have shafts, whose length would be included in the overall length of the cylinder.

The cylinder may be hollow or solid, but in either case the cylindrical surface will have some associated thickness of the specific material required to achieve the desired results. In particular, if the desired pattern of cavities is to have optical utility, the cylindrical surface may be a non-ferrous material or alloy, so that it may be machined successfully using a diamond tool. In addition the material preferably has a very small grain structure or is amorphous, and is free of inclusions, pits, voids and other defects that will affect the optical utility of the desired pattern. Examples of such materials include, but are not limited to: copper and copper-nickel alloys, nickel and nickel-phosphorus alloys and high purity aluminums.

The cylindrical surface into which the machining will occur can either be wrought or plated. In wrought form the material may comprise the entire cylindrical surface or it may be pressed or otherwise sleeved over an existing cylindrical surface made from a less expensive material. In plating, an electro-chemical process or alike is used to transfer the desired material uniformly and in a thin layer onto the outside of the cylinder surface. This plating process can also be done over a mandrel to create thin sleeve of the preferred material. This sleeve can then be patterned with the desired cavities or grooves and then transferred to the preferred cylinder for use in replication or material transfer. This sleeve can also be removed from the mandrel and transferred to the preferred cylinder prior to forming of the desired cavities.

After forming of the desired pattern of cavities, the sleeve can be removed and used as a belt in a replication or material transfer process. The sleeve can also be cut to size and used in the flat state for replication process such as injection molding or thermoforming.

The following examples illustrate the practice of this invention. They are not intended to be exhaustive of all possible variations of the invention. Parts and percentages are by weight unless otherwise indicated. The invention has been described in detail with particular reference to certain preferred embodiments thereof, but it will be understood that variations and modifications can be effected within the spirit and scope of the invention.

### Parts List

1; Light redirecting film system
2; Light redirecting film
5; Optical elements
6; Light exit surface
7; Light entrance surface
25; Optical coating
26; Light source
30; Optical diffuser layers
40; Back reflector
310; Cylinder
324; Axis of rotation
330; Length
334; Diameter
336; Length of cylinder
338; Shaft
340; Hole
BL; Backlight
C1; Cut
C2; Cut
C3; Cut
D; Display
F1; Cavity
F2; Cavity
M; Center point
N; Cavity
Q1; Rounded intersection point
Q2; Sharp transition
R; Rays
X; Horizontal spacing
Y; Vertical spacing

1. A method comprising electromechanical engraving a three-dimensional molding pattern in a rigid surface, wherein the rigid surface is configured to micro replicate according to the three-dimensional molding pattern.

2. The method of claim 1, wherein the electro-mechanical engraving is Gravure electromechanical engraving.

3. The method of claim 1, wherein the electromechanical engraving comprises:
moving the rigid surface at a constant velocity; and
moving a diamond stylus in and out of the rigid surface by applying an alternating voltage to a series of magnets to create a twisting motion in a rod, wherein the diamond stylus is attached to the rod to create cavities with are cumulatively the three-dimensional molding pattern.

4. The method of claim 1, wherein the rigid surface is a surface of a pattern roller having the three-dimensional molding pattern.

5. The method of claim 1, wherein the rigid surface is configured to micro replicate individual optical elements according to the three-dimensional molding pattern.

6. The method of claim 5, wherein the rigid surface is configured to micro replicate optical elements in a light redirecting film.

7. The method of claim 6, wherein the optical elements are of well defined shape to redistribute light passing through the light redirecting film toward a direction normal to the light redirecting film.

8. The method of claim 5, wherein at least some of the optical elements overlap.

9. The method of claim 5, wherein:
the individual optical elements are engraved in columns; and
the distance between columns is non-uniform.

10. The method of claim 5, wherein:
the individual optical elements are engraved in columns; and
the columns are engraved at the same axial location on the pattern roller.

11. The method of claim 5, wherein the individual optical elements are arranged in an irregular or pseudo-random pattern.

12. The method of claim 5 wherein:
the individual optical elements are arranged in columns; and
the electromechanical engraving comprises cutting the individual optical elements in a column to a depth less than their final depth, then cutting the individual optical elements in the column to their final depth.

13. A method comprising micro replicating optical elements in a light redirecting film, wherein:
said micro replicating optical elements uses a patterned roller with a pattern representing the optical elements; and
the pattern of the pattern roller is formed by a Gravure electro-mechanical engraving process.

14. The method of claim 13, wherein said micro replicating comprises extrusion roll molding.

15. The method of claim 14, wherein the extrusion roll molding forms the light redirecting film at a nip between a pattern roller and a pressure roller

16. The method of claim 13, wherein said micro replicating comprises UV curing.

17. The method of claim 13, wherein the method comprises embossing.

18. An apparatus comprising a rigid surface, wherein:
a three-dimensional molding pattern is formed in the rigid surface;
the three-dimensional molding pattern is formed by electro-mechanical engraving; and
the rigid surface is configured to micro replicate according to the three-dimensional molding pattern.

19. The apparatus of claim 18, wherein the electromechanical engraving is Gravure electromechanical engraving.

20. The apparatus of claim 18, wherein the rigid surface is a surface of a pattern roller having the molding pattern.

21. The apparatus of claim 18, wherein the rigid surface is configured to micro replicate optical elements according to the three-dimensional molding pattern.

22. The apparatus of claim 21, wherein the rigid surface is configured to micro replicate optical elements on a light redirecting film.

23. The apparatus of claim 21, wherein the optical elements are of well defined shape to redistribute light passing through the light redirecting film toward a direction normal to the light redirecting film.

24. The apparatus of claim 21, wherein:
the optical elements are individual optical elements; and
at least some of the optical elements overlap.

25. The apparatus of claim 21, wherein:
the optical elements are individual optical elements; and
the distance between individual optical elements in the direction of the pattern roller axis varies.

26. The apparatus of claim 21, wherein:
the optical elements are individual optical elements; and
the individual optical elements are arranged in an irregular or pseudo-random pattern.
